(19) United States
(12) Patent Application Publication
(10) Pub. No.: US 2005/0181727 A1
(43) Pub. Date: Aug. 18, 2005

(54) Cell phone home adaptor

(76) Inventor: Lawrence Russo, New York, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/779,956

(22) Filed: Feb. 14, 2004

(51) Int. Cl. H04B 7/00; H04B 1/06

(52) U.S. Cl. 455/41.2; 455/557; 455/344

(57) ABSTRACT

In a system having RJ-11 wired equipment and a mobile phone, where the mobile phone being capable of communicating with a wireless service provider, the system comprising a processor and a transceiver. The processor being capable of communication with the mobile phone and the RJ-11 wired equipment through said transceiver so that: a) incoming wireless signals from the wireless service are propagated over the RJ-11 wired equipment; and b) outgoing signals from the RJ-11 wired equipment are propagated over the wireless service.

### FIELD

The present invention generally relates to telephone services, and more specifically to a system which allows interconnection between a mobile phone and RJ-11 wired equipment service.

### BACKGROUND

Many telephone customers currently have more than one type of telephone service for their many communication needs. A typical consumer has both corded and cordless telephones to accommodate one or more RJ-11 wired equipment services. The same consumer also has at least one mobile phone to accommodate a cellular service.

When a consumer is in the comfort of their home, phones related to the RJ-11 wired equipment will often be found in each room. Accordingly, a call received by the RJ-11 wired equipment is unlikely to be missed by a person within the home. On the other hand, the same consumer is unlikely to carry their cellular phone around inside their home. The consumer is very likely to miss important calls received by their cellular phone while they are home. To solve this problem, it is desirable to enable the RJ-11 wired equipment within a home to receive calls that could only be reached through a cell phone.

U.S. Patent Publication No. US 2002/0155819 A1 (“'819”), published on Oct. 24, 2002, discloses a specialty handset that addresses the above described problems. The '819 publication discloses a cradle for receiving a mobile phone and a special cordless handset that has transceiver circuitry for both the RJ-11 wired equipment and the mobile service. Only one transceiver is active at a time and the mobile transceiver is activated upon placement of the mobile phone on the cradle.

The system of the '819 publication has several disadvantages. Each handset is considerably more complex, and thus more expensive, than normal RJ-11 wired equipment. In order to receive each incoming call, the user has to either tote each handset around a house or have a handset in close proximity to every room of the house. Accordingly, multiple expensive handsets are typically required in larger homes.

Another disadvantage of the system of the '819 publication arises because only one transceiver is activated at a time. The user must always find time to return to the cradle whenever the user wishes to switch between services or retrieve their mobile phone. The user is also likely to miss calls because only the mobile service or the RJ-11 wired equipment service is operable at any one time.

In light of the prior art, a telephone system is needed that is capable of converting digital cell phone service to new or preexisting RJ-11 wired equipment.

### SUMMARY

In a system having RJ-11 wired equipment and a mobile phone, where the mobile phone being capable of communicating with a wireless service provider, the system comprising a processor and a transceiver. The processor being capable of communication with the mobile phone and the RJ-11 wired equipment through said transceiver so that: a) incoming wireless signals from the wireless service are propagated over the RJ-11 wired equipment; and b) outgoing signals from the RJ-11 wired equipment are propagated over the wireless service.

### BRIEF DESCRIPTION OF THE FIGURES

In order that the manner in which the above recited objectives are realized, a particular description of the invention will be rendered by reference to specific embodiments thereof that are illustrated in the appended drawings. Understanding that the drawings depict only typical embodiments of the invention and are not therefore to be considered to be limiting of its scope, the invention will be described and explained with additional specificity and detail through the use of the accomBluetoothying drawings in which:

FIG. 1 is a schematic diagram of the present-inventive universal telephone system; and

FIG. 2 is a diagram of the present invention as applied in a residential building.

### DESCRIPTION OF THE EMBODIMENTS

A system 1 is disclosed that wirelessly communicates with a mobile phone 2 to transmit calls received by the mobile phone 2 to RJ-11 wired equipment 3 and transmit calls placed by the RJ-11 wired equipment 3 through the mobile phone 2. RJ-11 wired equipment, new and preexisting, is also known as Plain Old Telephone System, and will be referred to hereinafter as POTS.

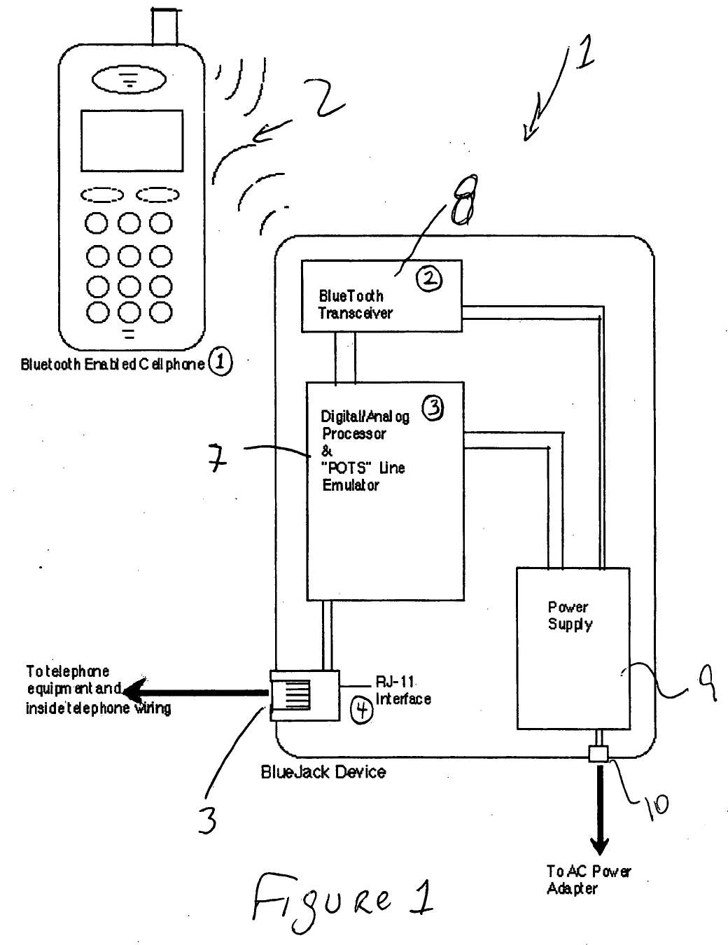

Turning to FIG. 1, the system 1 uses Bluetooth wireless technology to enable any home or office to easily route their calls through a cellular-telephone service provider 2 (making use of their cellular service account) via POTS.

Turning to FIG. 1, the mobile phone 2 is capable of receiving and transmitting signals over the wireless service network. The phone 2 is capable of using, for example, General Packet Radio Service (GPRS), available through AT&T Wireless, CDMA, GSM, or other such known service.

The Bluetooth enabled cellular phone 2 communicates with the Bluetooth enabled system 1. Specifically, inside the system 1 exists a Bluetooth transceiver 8 capable of communicating with the Bluetooth enabled phone 2 or any other Bluetooth enabled device. Whenever the system 1 senses another Bluetooth device 2 within transmission range, the Bluetooth transceiver 8 automatically becomes activated. The standard range for activating Bluetooth technology is within approximately 20 feet.

The system has a processor 7. The processor is connected to the POTS (not shown) through, for example, an interface capable of receiving POTS RJ-11 connectors 3. The system has a power supply 9 for powering the processor 7 and transceiver 8. The power supply 9 is a standard form of AC power supply having a cable 10 for connecting with a residential power source.

Once activated, the system 1 processes the digital transmission from the cellular phone 2 and routes calls from standard telephone devices through the service provider for the cellular phone 2. Examples of known providers are T-Mobile, AT&T, Sprint, etc.

The system 1 converts the data in a way that wholly emulates a standard POTS. This includes, but is not limited to, dial-tone generation, acceptance of touch tine and rotary command signals, tip and ring connections, DC current for voice and data, AC current for ring signals, on-hook and off-hook emulation, full duplex voice and data transmission as well as RJ-11 interface connectivity 3.

The notification system for the mobile phone 2 is turned off once the system is triggered and the transceiver 8 and processor 7 act entirely as the conduit to the mobile phone service. The processor 7 acts as a modem and is responsible for demodulating the wireless signals into voice data capable of being understood on POTS. When placing a call, the processor 7 is responsible for modulating signals so that voice can be transmitted over the wireless service network.

In use, the Bluetooth is terminated by moving the mobile phone 2 out of range from the Bluetooth transmitter 8. Once the Bluetooth is terminated, the processor 7 allows POTS calls originating from the phones to continue along the PSTN. After the Bluetooth is terminated, the mobile phone 2 directly notifies the user of incoming calls. The user is required to answer the call by interfacing with the mobile phone 2.

The system 1 allows users to make use of cellular service calling plans that may be more competitive than their POTS service would offer, while at the same time allowing users to keep and use standard, wired and non-wired POTS.

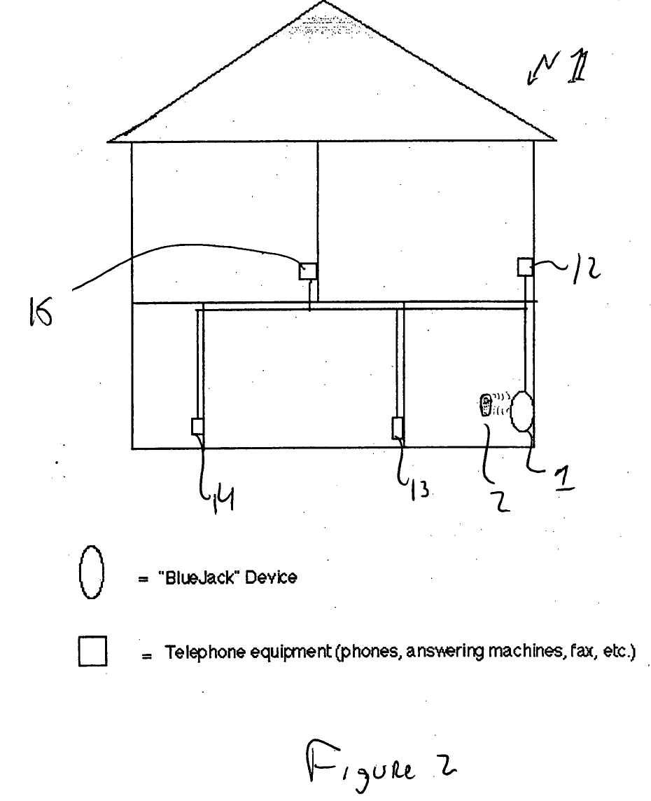

Turning to FIG. 2, the system is displayed in an environment 11 which may be residential or commercial. The present-invention allows a user to use his/her mobile phone 2 both at home or work as well as away from home or work. In any environment equipped with the system 1, the user is freed from carrying the mobile phone 2 around in order to receive or place telephone calls from any of a plurality of POTS 12, 13, 14 or 15. In addition, the integrated Bluetooth technology frees the user from having to place the mobile phone 2 in a fixed location each time the user enters the home.

Accordingly, a system 1 has been disclosed that wirelessly communicates with a mobile phone 2 to transmit calls received by the mobile phone 2 to POTS 3 and transmit calls placed by the POTS 3 through the mobile phone 2.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1) In a system capable of communicating with RJ-11 wired equipment and a mobile phone, where the mobile phone having a first Bluetooth transceiver and where the mobile phone being capable of communicating with a wireless service provider, the system comprising:
a second Bluetooth transceiver, said second Bluetooth transceiver being capable of communicating with the first Bluetooth transceiver;
the system being capable of communication with the RJ-11 wired equipment so that:
a) calls placed to the mobile phone are capable of being received on the RJ-11 wired equipment; and
b) calls placed from the RJ-11 wired equipment are capable of being propagated over the wireless service.
